(19) United States
(12) Patent Application Publication
(10) Pub. No.: US 2009/0246354 A1
(43) Pub. Date: Oct. 1, 2009

(54) Method and Device for Melting Sugar

(75) Inventors: Markus Henneberg, Magdeburg (DE); Matthias Ihlow, Moser (DE)

Correspondence Address: NORRIS, MCLAUGHLIN & MARCUS, 875 THIRD AVE, 18TH FLOOR, NEW YORK, NY, 10022, US

(73) Assignee: ZYLUM BETEILIGUNGSGESELLSCHAFT mbH & CO. PATENTE II KG

(21) Appl. No.: 11/575,378

(22) PCT Filed: Sep. 21, 2005
(86) PCT No.: PCT/DE2005/001716

§ 371 Date: May 11, 2007

(30) Foreign Application Priority Data
Sep. 23, 2004 (DE) 10 2004 046 477.4
Apr. 26, 2005 (DE) 10 2005 020 683.2

(51) Int. Cl. A23G 3/32; A23G 3/02; F28F 1/00

(52) U.S. Cl. 426/658; 165/177

(57) ABSTRACT

The invention relates to a method and an apparatus for melting sugar, referred to in the following as solid matter. The apparatus includes at least one melting tube (1) configured as a direct heat exchanger for melting the solid matter with an inlet (2) for the solid, an outlet (3) for the liquid produced by melting the solid matter through a phase transition, an inlet (4) for a heat exchange fluid, and an outlet (5) for the heat exchange fluid. The heat exchange fluid and the solid matter are in direct contact with one another inside the melting tube (1) for the purpose of heat exchange.

The invention relates to an apparatus for melting sugar or sugar solutions according to the features of the preamble of claim 1 and to a method for operating such apparatus.

During melting of sugar or sugar solutions with or without the addition of water to about 200° C., roasting products are generated which are used, for example, in the confectionery and liquor industry as flavor additives and food colors. The melting process which is also referred to as caramelizing, can thereby be steered more towards aroma formation or more towards color formation of the roasted products. However, an exceedingly long residence time of sugar or sugar solutions in the melting apparatus or a process flow with too high melting temperatures during the melting process can cause poor taste of the roasted products or even partial charring. To obtain identical batches of roasted products with consistent aroma and consistent color, not only must optimal process conditions be maintained, but also suitable melting equipment needs to be employed.

Conventional systems employed in industrial melting processes of sugar or sugar solutions for producing confectionaries and sugar products typically use discontinuously operated stirrer tanks. The sugar or sugar resolutions are hereby supplied to of the stirrer tank in batches and are subsequently heated under constant stirring. The container wall of the stirrer tank functions here as heat transfer surface, whereby the outside of the container wall is brought into contact with the heat exchange medium required for melting. To reach the melting temperature of the sugar or sugar solutions in the stirrer tank within a reasonable time and to avoid heat losses in the stirrer tank, the temperature of the employed heat exchange media may be substantially higher than the melting temperature of the sugar or the sugar solutions. Initially the sugar or sugar solutions residing in immediate proximity of the wall are heated from the outside to the inside of the container wall of the stirrer tank through heat conduction. Due to the small thermal-conduction resistance of the container wall of the stirrer tank, the inside of the container wall has excessive temperatures with a local distribution that is similar to that of the heat exchange medium on the outside of the stirrer tank. Due to unavoidable manufacturing tolerances for a hydraulically smooth surface of the inside of the container wall, the sugar or the sugar solutions can experience locally large residence times on the inside in spite of continuous movement of the stirrer. These local regions are characterized by charring of the roasted products, which necessarily causes an inferior quality of the roasted product batch or may make the roasted product batch completely unusable. The use of such melting equipment as several disadvantages. One major disadvantage is that this type of melting equipment is unable to provide a continuous process flow. In addition, the stirrer must be constantly serviced, which results in not insignificant operating costs. The main disadvantage of this discontinuous process flow, however, is that when the first sugar particles melt, those sugar particles that have not yet melted partially agglomerate. From this time on, heat conduction within the melt deteriorates, because the melt can no longer be thoroughly stirred, and the inhomogeneous melt also has no longer full surface contact with the container wall.

An apparatus for producing liquid sugar articles is known in the art, as disclosed in DE 199 51 462 A1. The apparatus includes at least one metering device for feeding sugar-containing dry components and liquid components, as well as a mixing device. The mixer is here implemented as a high-shear mixer, in which the dry components and the liquid components are rigorously stirred by a rotor and liquefied due to the generated friction heat.

DE 30 18 909 A1 describes a method for producing candies, in particular caramel candies, using a pressure reactor. The sugar melt is melted in the pressure reactor. Moreover, a gas is added to the pressure reactor at a higher pressure than the operating pressure of the pressure reactor. A characterizing feature of this invention is that after the melting process, a stirrer is operated and the gas is supplied to the pressure reactor through a gas-permeable plate which is arranged in the lower section of the pressure reactor below this stirrer.

The aforementioned inventions have the disadvantage that sugar cannot be continuously melted by using stirrer tanks or pressure reactors, because continuous loading with sugar to be melted and discharge of melted sugar must be realized. This leads to the aforementioned problems.

It is therefore an object of the invention to propose a method and an apparatus for melting sugar which eliminate the formation of agglomerates and lumps during the phase change, and which also enable continuous melting without creating overheated regions and without partial charring.

According to one aspect of the invention, the apparatus for melting sugar, subsequently referred to as solid matter, includes at least one melting tube formed as a direct heat exchanger with an inlet for the solid matter, an outlet for the liquid produced during melting of the solid matter through phase change, an inlet for a heat exchange fluid, and an outlet for the heat exchange fluid. The heat exchange fluid and the solid matter are in direct contact with one another in the melting tube for the purpose of heat exchange.

Unlike with conventional approaches, the sugar can be continuously melted with the melting tube. The change of temperature over time in the melting tube is nearly zero as a result of the continuous melting process, or stationary melting process, respectively.

The melting tube is preferably constructed of a perforated inner tube which contacts the melt, an outer tube oriented towards the surroundings, and an annular gap disposed between the inner tube and the outer tube. The annular gap, which can have any size, in cooperation with the perforated inner tube is formed as a second inlet for the heat transfer medium. Stated differently, the heat exchange fluid is applied to a first and a second end of the annular gap and is thereafter brought into contact with the melting sugar by passing through the perforations of the inner tube. By bringing the heat exchange fluid into direct contact with the sugar, the large full heat transfer surface of the sugar granulate ensures, on one hand, homogeneous heating of the sugar and, on the other hand, efficient heat exchange. The perforation of the inner tube of the melting tube is formed by openings in the form of nozzles and/or slits, wherein these openings along the surface of the inner tube ensure a laminar flow of the heat exchange fluid implemented as a gas. The laminar flow can be more or less well-defined depending on the selected inflow velocity of the heat exchange fluid.

In a preferred embodiment, several melting tubes can be provided which can be arranged in parallel or sequentially. In a sequential arrangement, the individual melting tubes are supplied successively with the sugar to be melted and the heat exchange fluid, whereas in a parallel arrangement, the individual melting tubes are supplied concurrently with the sugar to be melted and the heat exchange fluid.

In addition, for increasing the required heat supply, a tube heater can be provided which is preferably in contact with the inner tube of the melting tube.

According to the invention, the solid matter can be introduced into the melting tube and the fluid can be discharged from the melting tube at the axial ends or in the region of the jacket surface, i.e., on the side of the melting tube.

It has proven to be advantageous in practical application to arrange a fluidized bed apparatus upstream of the melting tube for purposely affecting certain state parameters, for example the temperature and moisture content, of the sugar present as solid matter. Following the state change of the sugar in the fluidized bed apparatus, the sugar has particularly advantageous properties aiding the melting process in the melting tube. The fluidized bed apparatus also includes at least one, but preferably several, spatially separated process regions, whereby adjacent process regions are coupled with one another by way of overflows and underflows formed as channels and cross-sectional openings. The process region has herein an inlet for the solid matter, an outlet for the solid manner with the changed properties, and an inlet and an outlet for the fluid in form of a gas or steam required for fluidizing the solid matter. In a situation where the fluidized bed apparatus has several process regions, each process region may have all or only some of the aforementioned inlets and outlets. Moreover, the individual process regions of the fluidized bed apparatus can have an identical size and geometry or can preferably be formed differently. The fluidized bed apparatus can also have several inflow chambers, wherein the individual process regions in the region of the inflow chambers are separated from each other by segmentations.

In another preferred embodiment of the invention, the individual process regions of the fluidized bed apparatus are cascaded with respect to one another. The overflows or underflows that couple respective adjacent process regions are alternatingly arranged in the flow direction such that a meander-like flow pattern of the solid matter is produced in the fluidized bed apparatus. In a situation where the overflows and underflows that couple two adjacent process regions are not arranged alternatingly, but rather on the same side, a straight flow pattern is attained.

The solid matter can be supplied to the fluidized bed apparatus and discharged from the fluidized bed apparatus on an end face, but also along a longitudinal side, of the fluidized bed apparatus.

The method for operating a device for melting sugar according to the apparatus features of claim 1 includes the following method steps
feeding the solid matter with arbitrary grain size into the melting tube by using the inlet of the solid matter,
feeding the heat exchange fluid into the melting tube by using the inlet of the heat exchange fluid,
surface wetting and heat exchange of the granular solid matter by the heat exchange fluid,
continuous phase change of the solid matter from the solid phase into the liquid phase,
discharging the liquid-phase solid matter from the melting tube by using the outlet for the melted solid matter, and
discharging the heat exchange fluid having changed properties from the melting tube by using the outlet of the heat exchange fluid.

For fluidization, the sugar present as solid matter is pretreated before being supplied to the melting tube by using a fluidized bed apparatus. For a state change, for example for changing the temperature, the gaseous or steam fluid is added to the sugar in the fluidized bed apparatus. Physically, during fluidization in the fluidized bed apparatus, the fluidized layer rises due to the formation of bubbles and the fluidized particles sink in regions without bubbles. The fluidized bed apparatus is therefore configured to achieve very effective material and heat exchange processes through intensive mixing. This is achieved, inter alia, by bringing the fluid and the solid matter into mutual contact in a cross-flow or a counterflow configuration.

Conversely, after exiting the fluidized bed apparatus, the heat exchange medium and the solid matter undergo heat exchange in the melting tube only in a parallel flow or a counterflow configuration.

The residence time of the solid matter in the melting tube depends primarily on the following parameters: grain size of the granulate of the solid matter and/or mass flow of the solid matter and/or geometry and dimensions of the melting tube and/or properties of the heat a change fluid.

The residence time of the solid matter in the fluidized bed apparatus depends primarily on the following parameters: mass flow of the solid matter and/or geometry, number and dimensions of the individual process regions of the fluidized bed apparatus.

The fluidization properties of the solid matter can be adjusted differently in the individual process regions. At the lowest velocity, only flow-through occurs through the fixed sugar bed which is arranged on several grates positioned next to each other or on top of one another. However, at a very high velocity, the limit for airborne particles is reached.

Through the preferably alternating placement of the overflows and underflows that couple respective two adjacent process regions, a meander-like solid matter transport, or a meander-like flow pattern, through the fluidized bed apparatus is obtained.

In another embodiment of the invention, the heat required for thermal treatment of the sugar in the melting tube and/or in the fluidized bed apparatus can be supplied through convection and/or radiation.

In general, the residence time of the sugar to be melted in the melting tube can be adjusted via the size of the melting tube and the flow velocity of the sugar to be melted and/or of the heat exchange fluid. The temperature of the solid and liquid sugar in the melting tube can be influenced via the properties of the heat exchange fluid and the tube heater, because heat is exchanged between the sugar and the heat exchange fluid through convective heat transfer and thermal radiation, as well as through heat transfer from the inner tube to the sugar and to the heat exchange fluid.

The significant advantages and features of the invention over the present state of the art are essentially:
trouble-free continuous melting process by using a compact melting tube,
no rotational or translational motion of a stirrer provided for mixing is required,
prevention of formation of agglomerates and lumps, because in a continuous melting process, the change of temperature over time in the melting tube is approximately zero, and the sugar particles in the melting tube are transported as a solid matter cloud, which minimizes mutual contact between the sugar particles,
prevention of overheated regions in the melting tube, because the sugar granulate present as solid matter is contacted completely and uniformly over the entire surface by the heat exchange fluid that flows through and around.

Additional features and advantages of the invention will be appreciated by a skilled artisan from the following detailed description of preferred embodiments with reference to the appended drawings, which show in:

FIG. 1 a schematic diagram of a melting tube implemented as a direct heat exchanger in an embodiment as a counterflow exchanger,

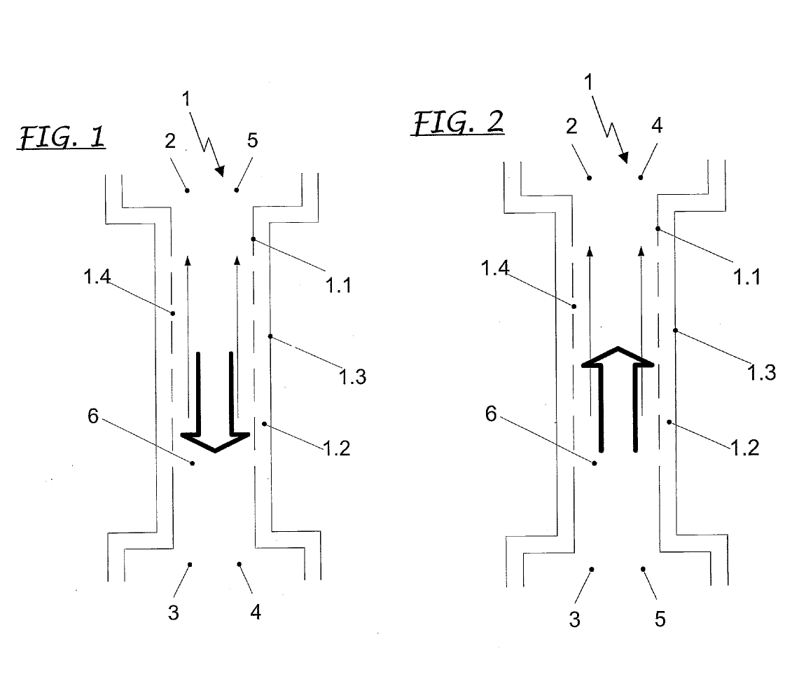

FIG. 2 a schematic diagram of a melting tube implemented as a direct heat exchanger in an embodiment as a parallel exchanger,

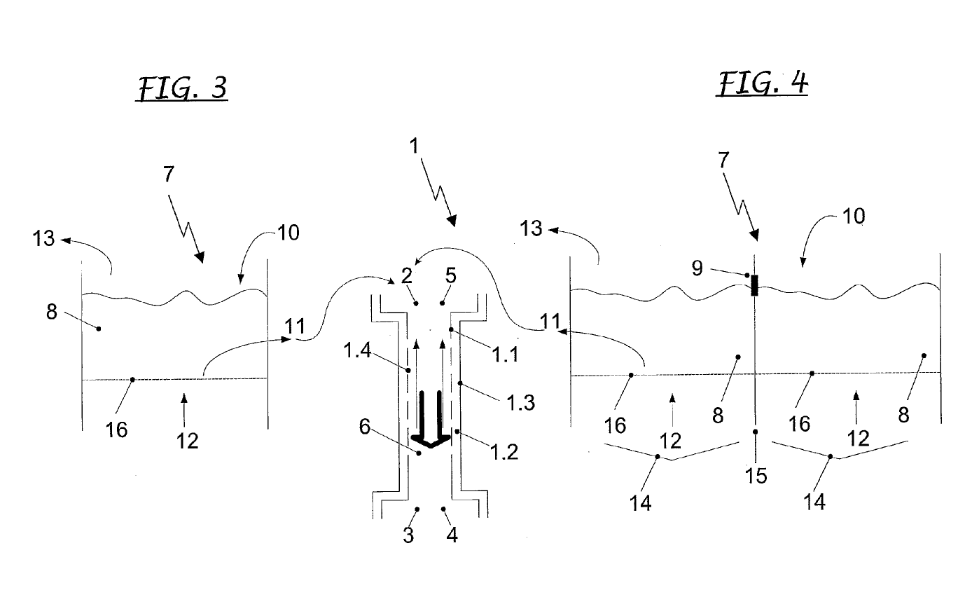

FIG. 3 a schematic diagram of a fluidized bed apparatus coupled with the melting tube, and

FIG. 4 a schematic diagram of a fluidized bed apparatus coupled with the melting tube and having several process regions.

FIG. 1 illustrates an apparatus according to the invention for melting sugar which in the illustrated example includes a single melting tube 1 implemented as a direct heat exchanger. The melting tube 1 consists herein of a perforated inner tube 1.1 which contacts the melt 6, an outer tube 1.3 oriented towards the surroundings, and an angular gap 1.2 disposed between the inner tube 1.1 and the outer tube 1.3. The annular gap 1.2 can have an arbitrary size and, in cooperation with the perforated inner tube 1.1, is formed as a second inlet for the heat transfer medium. The melting tube 1 also includes a first inlet 2 for the solid matter, and outlet 3 for the liquid produced during melting of the solid matter through phase change, and an inlet 4 for a heat exchange fluid, and an outlet 5 for the heat exchange fluid. The heat exchange fluid implemented as a gas and the sugar are brought into contact with each other in a counter flow configuration, so that for manufacturing-related reasons both the inlet 2 and the outlet 3 for the solid matter which is present as sugar, and the inlet 4 and the outlet 5 for the heat exchange fluid are arranged alternatingly on both ends of the melting tube. In the depicted example, the melting tube 1 is oriented vertically and the inlet 2 for the sugar which has not yet melted is arranged in the upper region, which is particularly advantageous for discharging the liquid generated during melting of the solid matter through phase change by way of gravity. The heat exchange fluid is supplied using inlet 4 which is arranged opposite of inlet 2 for the sugar to be melted. Accordingly, the inlet 2 for the sugar to be melted and the outlet 5 for the heat exchange medium, as well as the inlet 4 for the heat exchange medium and the outlet 3 for the liquid sugar melt are each arranged on a common side of the melting tube 1. The melting tube 1 is supplied with the various substances participating in the phase change of the sugar, and the method for operating the melting tube is performed as follows: the melting tube 1 is supplied with the desired mass flow of sugar to be melted by using inlet 2. At the same time, the heat exchange fluid is supplied to the melting tube 1 in a counterflow arrangement via inlet 4, so that the melted sugar performs a directional motion depending on the velocity and the inflow angle. The thermal energy required for thermal treatment of the sugar is supplied to the sugar by the heat exchange fluid, which is supplied to the melt 6 of the melting tube 1, on one hand, via the first inlet 4 and, on the other hand, via the annular gap 1.2 and the perforated interior wall 1.1. The heat exchange fluid is supplied to the annular gap 1.2 at one end of the melting tube 1, whereby the heat exchange fluid is distributed over the length of the melting tube and flows through the openings 1.4 of the perforated inner tube as a laminar flow with sufficient velocity along with the surface of the inner tube 1.1 oriented toward the melt 6. In this way, sedimentation of unmelted or melted sugar can be directly controlled depending on the velocity and the direction of the heat exchange fluid. The liquid sugar present after phase change leaves the melting tube 1 at outlet 3.

FIG. 2 illustrates an apparatus according to the invention for melting sugar which in the depicted example includes a single melting tube 1 formed as a direct heat exchanger. The melting tube 1 has the same construction as that of FIG. 1, with the only difference that the melting tube 1 is configured as a parallel flow tube. Parallel flow of the two associated substances in the melting tube 1 is achieved not only by the arrangement of the two inlets 2, 4 and the two outlets 3, 4 on respective common ends of the melting tube, but it is also necessary to match the velocities and the mass and/or volume flows of the two associated substances.

FIG. 3 is a schematic diagram of a fluidized bed apparatus 7 which is directly or indirectly coupled with the melting tube 1. While only a single process region 8 is depicted in FIG. 3, the fluidized bed apparatus 1 of FIG. 4 includes several process regions 8. Because the fluidized bed apparatus 7 and the melting tube 1 in FIGS. 3 and 4 cooperate essentially in the same way, the following discussion refers both to FIG. 3 and to FIG. 4. The fluidized bed apparatus 7 includes one or more grates 16 on which the sugar is placed to form a fixed bed. The grates 16 are filled with the sugar in form of solid particles via the inlet 10, i.e., by supplying and controlling the mass and/or volume flow. The fluid or fluidization medium (for example a gas) required for forming a two-phase mixture is supplied via the inlet 12. The sugar is fluidized above the grates 16. The enthalpy flow coupled to the mass and/or volume flow of the fluid is used for thermal treatment of the sugar. The sugar is thermally treated inside the fluidized bed apparatus 7 such that the fluidized sugar discharged through the outlet 11 of the fluidized bed apparatus 7 has the required properties for the melting tube 1. The sugar attains a low viscosity during fluidization and is thereby tempered, depending on the temperature of the fluid. After thermal and physical treatment of the sugar, the gaseous or steam fluid employed for fluidization exits the fluidized bed apparatus 7 through outlet 13, and can preferably supplied again to the inlet 12 of the fluidized bed apparatus 7 for reuse by using a recirculating loop (not shown). Thermal treatment methods in this context include tempering and drying. Following the thermal treatment of the sugar in the fluidized bed apparatus 7, the fluidized sugar is supplied to the inlet 2 of the melting tube 1 via outlet 11 of the fluidized bed apparatus 7. Additional melting of the sugar is performed according to the description relating to FIGS. 1 and 2.

FIG. 4 shows a fluidized bed apparatus 7 having two inflow chambers 14 arranged side-by-side. Each of these inflow chambers 14 is arranged upstream of a process region 8. The process regions 8 are separated from one another in the region of the inflow chambers 14 by segmentations. However, the process regions 8 are coupled with one another by using overflows and/or underflows 9 implemented as channels and cross-sectional openings. The outflow process region, shown on the left side of FIG. 4, as viewed by an observer, has an outlet 11 for the solid matter with the changed properties, in particular the temperature, wherein the outlet 11 is directly or indirectly coupled with the inlet 2 of the melting tube.

### LIST OF REFERENCE SYMBOLS

1 melting tube
1.1 inner tube
1.2 annular gap
1.3 outer tube
1.4 opening of the inner tube
2 inlet for the solid matter
3 outlet for the melted solid matter
4 inlet for the heat exchange fluid
5 outlet for the heat exchange fluid
6 melt
7 fluidized bed apparatus
8 process regions of the fluidized bed apparatus
9 overflows and underflows
10 inlet for the solid matter of the fluidized bed apparatus
11 outlet for the solid matter of the fluidized bed apparatus
12 inlet for the fluid of the fluidized bed apparatus
13 outlet for the fluid of the fluidized bed apparatus
14 inflow chambers of the fluidized bed apparatus
15 segmentations
16 grate, flow bottom

1. Apparatus for melting sugar, subsequently referred to as solid matter, comprising at least one melting tube formed as a direct heat exchanger with:
a. an inlet for the solid matter,
b. an outlet for liquid produced during melting of the solid matter through phase change,
c. an inlet for a heat exchange fluid, and
d. an outlet for the heat exchange fluid,
wherein the heat exchange fluid and the solid matter are in direct contact with one another in the at least one melting tube for the purpose of heat exchange.

2. Apparatus according to claim 1, wherein the melting tube is constructed of a perforated inner tube, an outer tube oriented towards the surroundings, and an annular gap disposed between the inner tube and the outer tube, wherein the annular gap in cooperation with the perforated inner tube is formed as an additional inlet for the heat exchange fluid.

3. Apparatus according to claim 2, characterized in that a perforation of the inner tube of the melting tube is formed by openings in the form of nozzles and/or slits, wherein these openings disposed along the surface of the inner tube ensure a laminar flow of the heat exchange fluid implemented as a gas.

4. Apparatus according to claim 1, wherein the melting tube comprises a tube heater.

5. Apparatus according to claim 1, further comprising a fluidized bed apparatus, which is arranged upstream of the melting tube and is provided for a targeted change of state of the solid matter.

6. Apparatus according to claim 5, wherein the fluidized bed apparatus comprises several spatially separated process regions, wherein adjacent process regions are each mutually coupled by using overflows and/or underflows formed as channels and cross-sectional openings, and wherein an inflow-side process region includes an inlet for the solid matter and an outflow-side process region includes an outlet for the solid matter having changed state variables, and wherein at least one of the process regions is provided with an inlet for fluid required for fluidizing the solid matter.

7. Apparatus according to claim 6, characterized in that the spatially separated process regions of the fluidized bed apparatus have different dimensions and geometries.

8. Apparatus according to claim 5, wherein the fluidized bed apparatus comprises several inflow chambers, as well as segmentations separating individual process regions from one another in a region of the inflow chambers.

9. Apparatus according to claim 6, wherein the spatially separated process regions of the fluidized bed apparatus are cascaded with respect to one another, wherein the overflows or underflows that couple respective adjacent process regions are alternatingly placed in a flow direction such that a meander-like flow pattern of the solid matter is produced in the fluid bed apparatus.

10. Method for operating an apparatus for melting sugar, subsequently referred to as solid matter, said apparatus comprising at least one melting tube formed as a direct heat exchanger, the method comprising the following steps:
feeding the solid matter with arbitrary grain size into the melting tube by using an inlet of the solid matter,
feeding a heat exchange fluid into the melting tube by using an inlet of the heat exchange fluid,
surface wetting and heat exchange of the granular solid matter by the heat exchange fluid,
continuous phase change of the solid matter from the solid phase into the liquid phase,
discharging the liquid-phase solid matter from the melting tube by using an outlet for the melted solid matter, and
discharging the heat exchange fluid having changed properties from the melting tube by using an outlet of the heat a change fluid.

11. Method according to claim 10, further comprising the steps of fluidizing the solid matter fluidized by using a fluidized bed apparatus, adding a fluid to the fluidized bed apparatus for changing a state of the solid matter, and feeding the solid matter having the changed state into the melting tube.

12. Method according to claim 10, wherein the heat exchange medium and the solid matter, optionally already fluidized, undergo heat exchange in the melting tube in a parallel flow or in a counter-current flow configuration.

13. Method according to claim 11, wherein for forming a two-phase mixture, the heat exchange fluid and the solid matter are brought into contact in the fluidized bed apparatus in a cross-current flow or in a counter-current flow configuration.

14. Method according to claim 10, wherein a residence time of the solid matter in the melting tube depends on the parameters:
a. grain size of the granulate of the solid matter and/or
b. mass flow of the solid matter and/or
c. geometry and dimensions of the melting tube and/or
d. properties of the heat exchange fluid.

15. Method according to claim 11, wherein a residence time of the solid matter in the fluidized bed apparatus depends on the parameters:
a. mass flow of the solid matter and/or
b. geometry, number and dimensions of individual process regions of the fluid bed apparatus.

16. Method according to claim 11, wherein a velocity of the solid matter in process regions of the fluidized bed apparatus ranges from a rest position in a traversed fixed bed to a limit range of airborne transport.

17. Method according to claim 11, wherein a transport of the solid matter through the fluidized bed apparatus occurs in meander form.

18. Method according to claim 11, wherein a heat for heat treatment of the sugar is supplied to the melting tube and/or in the fluidized bed apparatus through convection and/or radiation.

19. Method according to claim 11, wherein different conditions can be set in the melting tube and in individual process regions of the fluidized bed apparatus, or both.
